(19) United States
(12) Patent Application Publication
(10) Pub. No.: US 2015/0323002 A1
(43) Pub. Date: Nov. 12, 2015

(54) HYDRODYNAMIC BEARING DEVICE, SPINDLE MOTOR HAVING THE SAME, AND RECORDING DISK DRIVING DEVICE

(71) Applicant: SAMSUNG ELECTRO-MECHANICS CO., LTD., Suwon-si (KR)

(72) Inventors: Ho Kyung JANG, Suwon-si (KR); Kyung Moon JUNG, Suwon-si (KR); Yong Sik KIM, Suwon-si (KR); Jae Hyuk KIM, Suwon-si (KR)

(73) Assignee: SAMSUNG ELECTRO-MECHANICS CO., LTD., Suwon-si (KR)

(21) Appl. No.: 14/703,294

(22) Filed: May 4, 2015

(30) Foreign Application Priority Data
May 8, 2014 (KR) 10-2014-0054585
Sep. 11, 2014 (KR) 10-2014-0120213

(51) Int. Cl. F16C 17/10; G11B 19/28; G11B 19/247; H02K 7/08

(52) U.S. Cl. CPC F16C 17/107; H02K 7/085; G11B 19/28; G11B 19/247

(57) ABSTRACT

A hydrodynamic bearing device includes a stator and a rotor. The rotor forms a bearing clearance and a sealing part connected with the bearing clearance. A liquid-vapor interface is disposed in the sealing part together with the stator, and the bearing clearance is filled with a lubricating fluid. The stator and the rotor form a storage space connected with the sealing part to receive the lubricating fluid. The storage space has a region in which force applied to the liquid-vapor interface increases by a capillary phenomenon at a time that the lubricating fluid leaks to fill the bearing clearance.

### CROSS-REFERENCE TO RELATED APPLICATIONS

This application claims the priority and benefit under 35 USC 119(a) of Korean Patent Application No. 10-2014-0054585 filed on May 8, 2014, and Korean Patent Application No. 10-2014-0120213 filed on Sep. 11, 2014, with the Korean Intellectual Property Office, the disclosures of which are incorporated herein by reference.

### BACKGROUND

1. Field

The present disclosure relates to a hydrodynamic bearing device, a spindle motor having the same, and a recording disk driving device.

2. Description of Related Art

In general, a so-called fixed-shaft type spindle motor, in which a shaft having excellent vibration characteristics is fixed to a base member, is mounted on an information recording and reproducing device, such as a recording disk driving device for a server.

Meanwhile, in the case in which a fixed shaft is provided in a driving motor, a plurality of liquid-vapor interfaces are formed in a hydrodynamic bearing device of the driving motor, filled with a lubricating fluid. In the case in which the plurality of liquid-vapor interfaces are formed as described above, during the process of assembling the recording disk driving device, a pressure differential between an interior and an exterior of the hydrodynamic bearing device is generated by a blowing process. As a result of such a pressure differential, the lubricating fluid may easily leak to the exterior of the hydrodynamic bearing device to then dissipate.

In order to prevent the lubricating fluid from dissipating, an injection amount of the lubricating fluid is decreased. However, a lifespan of a motor decreases due to evaporation of the small amount of injected lubricating fluid.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In accordance with an embodiment, there is provided a hydrodynamic bearing device, including a stator; and a rotor forming a bearing clearance and a sealing part connected with the bearing clearance, wherein a liquid-vapor interface is disposed in the sealing part together with the stator, and the bearing clearance is filled with a lubricating fluid, wherein the stator and the rotor form a storage space connected with the sealing part to receive the lubricating fluid, and wherein the storage space has a region in which force applied to the liquid-vapor interface increases by a capillary phenomenon at a time that the lubricating fluid leaks to fill the bearing clearance.

The storage space may have a volume equal to or greater than a volume of the lubricating fluid filling the bearing clearance.

The storage space may include a first storage space formed in an axial direction, a second storage space connected with the first storage space and having a gap increasing upwardly in the axial direction, and a third storage space connected with the second storage space and having a gap wider than a gap of the second storage space.

The bearing clearance may include a flow suppression clearance having a gap narrower than gaps of other portions of the bearing clearance to suppress of a flow of the lubricating fluid.

The flow suppression clearance may be formed in the bearing clearance to be connected with the sealing part.

In accordance with another embodiment, there is provided a hydrodynamic bearing device, including a stator; and a rotor forming a bearing clearance and a sealing part connected with the bearing clearance, wherein a liquid-vapor interface is disposed in the sealing part together with the stator, and the bearing clearance is filled with a lubricating fluid, the stator and the rotor form a storage space connected with the sealing part to receive the lubricating fluid leaked from the bearing clearance, and the bearing clearance includes a sealing reinforcement part formed therein, forming a labyrinth seal with the sealing part and including a gap of variable size.

The storage space may have a region in which force applied to the liquid-vapor interface increases by a capillary phenomenon as the lubricating fluid leaks.

The sealing reinforcement part may include a flow suppression clearance connected with the sealing part and having a gap narrower than a gap of the sealing part, and a clearance expansion part connected with the flow suppression clearance and having a gap wider than a gap of the flow suppression clearance.

The clearance expansion part may be formed to be inclined from a portion of the clearance expansion part connected with the flow suppression clearance.

The flow suppression clearance may have a gap narrower than gaps of other portions of the bearing clearance.

In accordance with another embodiment, there is provided a spindle motor, including a base member; a lower thrust member connected to the base member; a shaft connected to the lower thrust member and including an upper thrust member extended from a flange part at an upper end portion of the shaft; and a rotating member configured to form a bearing clearance together with the lower thrust member and the shaft, wherein the bearing clearance is filled with a lubricating fluid, the upper thrust member and the flange part form a storage space configured to receive the lubricating fluid filling the bearing clearance, together with the rotating member, and a lower surface of the upper thrust member and a surface of the rotating member facing the lower surface of the upper thrust member form a flow suppression clearance.

The storage space may have a region in which force applied to a liquid-vapor interface moved due to the leakage of the lubricating fluid by a capillary phenomenon is increased.

The flow suppression clearance may be disposed in the bearing clearance and has a gap narrower than gaps of other portions of the bearing clearance.

The flow suppression clearance may be connected with a sealing part formed at a distal end of the bearing clearance and the storage space is extended from the sealing part.

The bearing clearance may include a sealing reinforcement part including the flow suppression clearance and a clearance expansion part connected with the flow suppression clearance and having a gap wider than a gap of the flow suppression clearance, wherein the sealing reinforcement part forms a labyrinth seal in connection with the sealing part and includes a gap of a variable size.

The flow suppression clearance may have a gap of 25 μm or less to prevent scattering of the lubricating fluid due to a pressure differential of 2 KPa.

The storage space may include a first storage space formed in an axial direction, a second storage space connected with the first storage space and having a gap increasing upwardly in the axial direction, and a third storage space connected with the second storage space and having a gap wider than a gap of the second storage space.

In accordance with another embodiment, there is provided a recording disk driving device the spindle motor described above configured to rotate a recording disk; a head transfer part transferring a head detecting information of the recording disk mounted on the spindle motor to the recording disk; and an upper case assembled with the base member to form an internal space to receive the spindle motor and the head transfer part.

In accordance with an embodiment, there is provided a hydrodynamic bearing device, including a stator including a lower thrust member and a shaft; and a rotor forming a bearing clearance and a first sealing part connected with the bearing clearance, wherein a liquid-vapor interface is disposed in the first sealing part together with the stator, and the bearing clearance is filled with a lubricating fluid, the stator and the rotor form a storage space connected with the first sealing part to receive the lubricating fluid, and a lower surface of an upper thrust member of the shaft and a facing surface of a rotating member of the rotor facing the lower surface of the upper thrust member form a flow suppression clearance, the first sealing part is formed between the upper thrust member and the rotating member, a second sealing part is formed between the lower thrust member and the rotating member, and when a pressure, P1, is applied to a first liquid-vapor interface disposed in the second sealing part and a pressure, P2, is applied to a second liquid-vapor interface disposed in the first sealing part, a pressure differential between P1 and P2 is defined as P1−P2.

The storage space may include a volume greater than a volume of the lubricating fluid filling the bearing clearance.

When P1 is greater than P2, a pressure may be applied to outside of the bearing clearance in the second liquid-vapor interface, moving up the second liquid-vapor interface towards the exterior of the first sealing part.

The flow suppression clearance may be connected with the first sealing part and disposed in the bearing clearance.

The flow suppression clearance may include a gap narrower than gaps of other portions of the bearing clearance.

As the lubricating fluid leaks into the storage space, force may be applied to the liquid-vapor interface by the capillary phenomenon is gradually increased.

The lubricating fluid may be leaked from the bearing clearance until a pressure differential of a force, which acts in a direction opposite to a flow direction of the lubricating fluid by the flow suppression clearance, and a force, which acts on the liquid-vapor interface moved to the storage space in the direction opposite to the flow direction of the lubricating fluid by the capillary phenomenon, becomes equal to a force applied to the lubricating fluid.

A leakage speed of the lubricating fluid may decrease as the lubricating fluid passes through a sealing reinforcement part and is introduced into the storage space.

Other features and aspects will be apparent from the following detailed description, the drawings, and the claims.

### BRIEF DESCRIPTION OF DRAWINGS

These and/or other aspects will become apparent and more readily appreciated from the following description of the embodiments, taken in conjunction with the accompanying drawings in which:

FIG. 1 is a schematic cross-sectional view illustrating a spindle motor including a hydrodynamic bearing device, according to an embodiment;

FIG. 2 is an enlarged view of part A of FIG. 1;

FIG. 3 is an enlarged view illustrating part B of FIG. 2;

FIG. 4 is a view illustrating an operation of the spindle motor including the hydrodynamic bearing device, according to an embodiment;

FIG. 5 is an enlarged view illustrating part C of FIG. 4;

FIG. 6 is a schematic cross-sectional view illustrating a spindle motor including a hydrodynamic bearing device, according to another embodiment;

FIG. 7 is an enlarged view illustrating part D of FIG. 6;

FIG. 8 is an enlarged view illustrating part E of FIG. 7;

FIG. 9 is a view illustrating an operation of the hydrodynamic bearing device, according to another embodiment; and

FIG. 10 is a schematic cross-sectional view illustrating a recording disk driving device, according to an embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or methods described herein will be apparent to one of ordinary skill in the art. For example, the sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

Throughout the drawings and the detailed description, the same reference numerals refer to the same elements. The drawings may not be to scale, and the relative size, proportions, and depiction of elements in the drawings may be exaggerated for clarity, illustration, and convenience.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

It will be understood that when an element or layer is referred to as being “on” or “connected to” another element or layer, it can be directly on or connected to the other element or layer or through intervening elements or layers may be present. In contrast, when an element is referred to as being “directly on” or “directly connected to” another element or layer, there are no intervening elements or layers present. Like reference numerals refer to like elements throughout.

As used herein, the term “and/or” includes any and all combinations of one or more of the associated listed items. It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another region, layer or section. These terms do not necessarily imply a specific order or arrangement of the elements, components, regions, layers and/or sections. Thus, a first element, component, region, layer or section discussed below could be termed a second element, component, region, layer or section without departing from the teachings description of the present invention.

Spatially relative terms, such as “lower,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

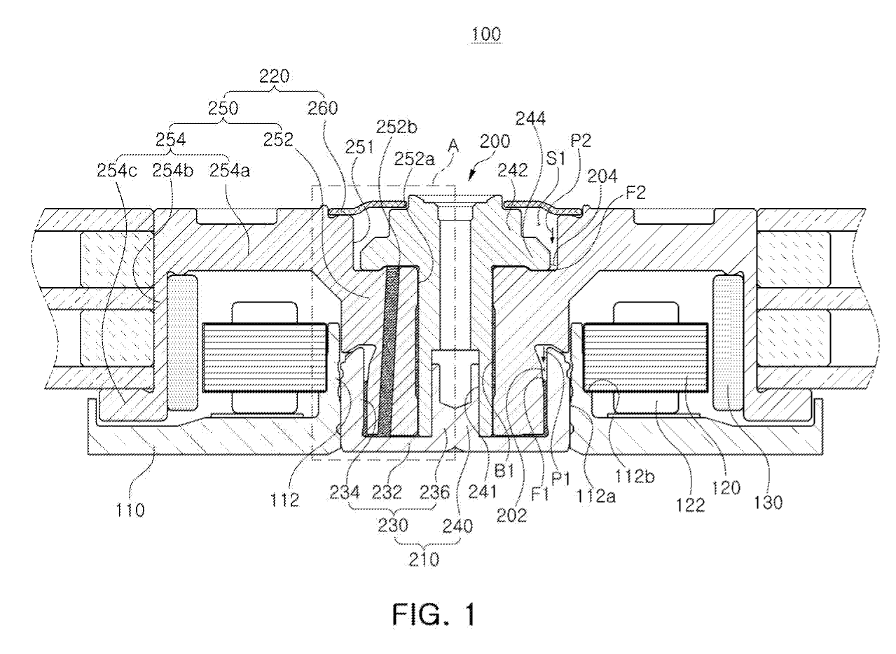

FIG. 1 is a schematic cross-sectional view illustrating a spindle motor including a hydrodynamic bearing device, according to an embodiment.

Referring to FIG. 1, a spindle motor 100, according to an embodiment, includes a base member 110, a stator core 120, a driving magnet 130, and a hydrodynamic bearing device 200.

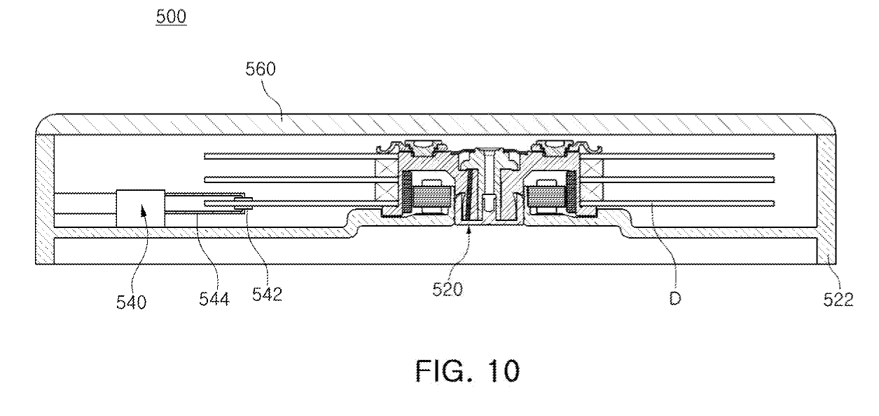

In one illustrative example, the spindle motor 100 is a small, high-precision, high-reliability electric motor used in an information recording and reproducing device such as a recording disk driving device 500 (see FIG. 10) to be described below, or other electronic devices such as a hard disk drive (HDD).

The base member 110 includes an installation part 112 in which the stator core 120 is installed. An installation hole 112a into which the hydrodynamic bearing device 200 is inserted is formed in the installation part 112, and the installation part 112 is extended upwardly in an axial direction.

Further, a support surface 112b supporting the stator core 120 is formed at an outer peripheral surface of the installation part 112. As an example, the stator core 120 is fixedly attached to the installation part 112 so as to be seated on the support surface 112b of the installation part 112. In this example, the stator core 120 is bonded and attached to the installation part 112 by at least one of a press-fitting method and an adhesion method. In an alternative example, the stator core 120 is connected or operatively connected to the installation part 112.

Although the case in which an inner peripheral surface of the stator core 120 is seated on and installed so as to face the installation part 112 of the base member 110 is described by way of example, embodiments of the present disclosure are not limited thereto. For example, the stator core 120 may be attached, fixed, connected, or operatively connected to a separate installation member.

The stator core 120 may be fixedly attached to the installation part 112 of the base member 110 as described above. A coil 122 is wound around the stator core 120, and when power is supplied to the coil 122, an electromagnetic force generates a driving force produced by interaction between the stator core 120 and a driving magnet 130.

In one configuration, the driving magnet 130 is fixedly attached to an inner surface of a rotating member 250 to be described below. For example, the driving magnet 130 is fixedly attached, connected, or operatively connected to the rotating member 250 so as to be disposed to face the stator core 120 to generate a driving force to rotate the rotating member 250 through interaction thereof with the stator core 120.

In one example, the driving magnet 130 is a permanent magnet generating magnetic force having a predetermined strength by alternately magnetizing an N pole and an S pole thereof in a circumferential direction.

The hydrodynamic bearing device 200 includes a stator 210 and a rotor 220. The stator 210 and the rotor 220 form a bearing clearance B1 filled with a lubricating fluid.

The stator 210 includes a lower thrust member 230 and a shaft 240. The rotor 220 includes the rotating member 250 and a cap member 260.

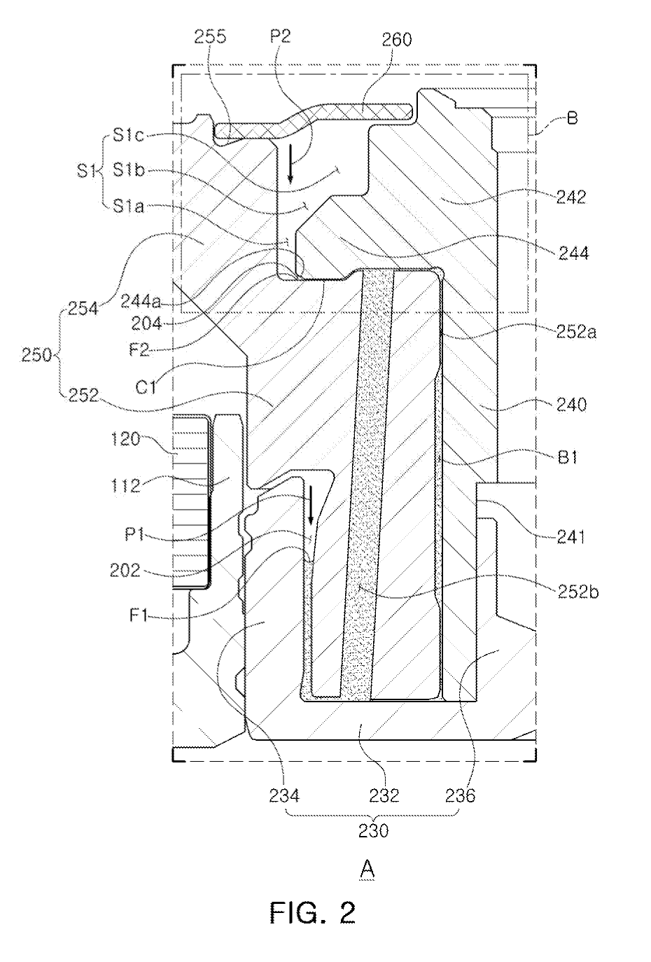

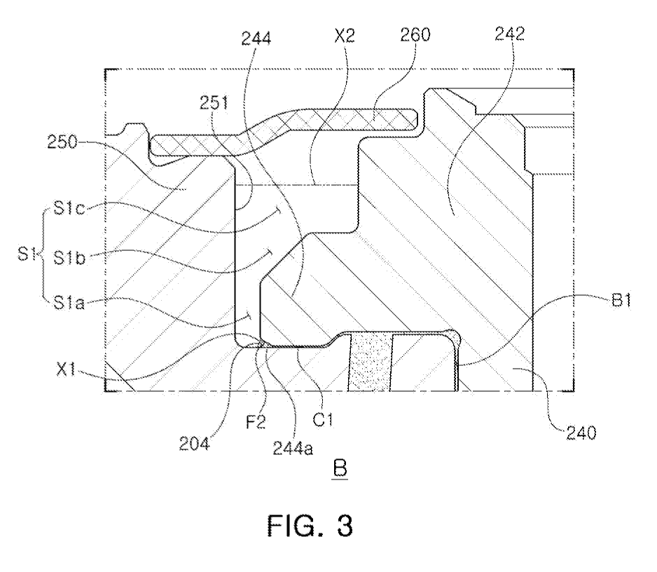

The hydrodynamic bearing device 200 will be described in more detail with reference to FIGS. 2 and 3.

FIG. 2 is an enlarged view of part A of FIG. 1, while FIG. 3 is an enlarged view illustrating part B of FIG. 2.

As shown in FIGS. 1, 2, and 3, the stator 210 and the rotor 220 form the bearing clearance B1, which is filled with the lubricating fluid. Sealing parts 202 and 204 are connected with the bearing clearance B1 and having liquid-vapor interfaces F1 and F2 disposed therein.

The stator 210 and the rotor 220 form a storage space S1 connected with the sealing part 204. The storage space S1 receives all of the lubricating fluid filling the bearing clearance B1 at the time of leakage or flow of the lubricating fluid filling the bearing clearance B1.

A detailed description of the storage space S1 will be provided below.

First, the lower thrust member 230 and the shaft 240 of the stator 210 will be described. In one example, the lower thrust member 230 is fixedly attached to the base member 110.

For example, the lower thrust member 230 is insertedly disposed in the installation hole 112a of the installation part 112 and attached to the base member 110 so that an outer peripheral surface thereof is bonded to an inner peripheral surface of the installation part 112.

In this case, the lower thrust member 230 is fixedly attached to the installation part 112 by at least one of an adhesion method, a press-fitting method, and a welding method. In an alternative configuration, the lower thrust member 230 is connected or operatively connected to the installation part 112 through a mechanical connector.

The lower thrust member 230 includes a disk part 232 having a disk shape, a sealing wall part 234 extended upwardly from an edge of the disk part 232 in the axial direction, and a coupling part 236 extended upwardly from a central portion of the disk part 232 in the axial direction to thereby be coupled to the shaft 240.

In addition, together with the rotating member 250, the lower thrust member 230 forms the bearing clearance B1 filled with the lubricating fluid. Further, as illustrated in FIG. 2, together with the rotating member 250, the sealing wall part 234 forms the sealing part 202 in which an interface between the lubricating fluid and air, for example, a liquid-vapor interface F1, is formed.

The shaft 240 has a lower end portion fixedly attached to the lower thrust member 230 and includes a flange part 242 extended from an upper end portion thereof in a radial direction toward an outer peripheral surface of the rotor hub 254. The shaft 240 has an upper end portion fixedly attached to an upper thrust member 244 extended from the flange part 242 in the axial direction. In an alternative configuration, the lower end portion and the upper end portion of the shaft 240 is removably attached to the lower thrust member 230 and the upper thrust part 240.

As an example, a coupling groove 241 into which the coupling part 236 of the lower thrust member 230 is inserted is formed in a lower end portion of the shaft 240. The coupling part 236 is inserted into the coupling groove 241, such that the shaft 240 is fixedly attached to the lower thrust member 230. For example, the spindle motor 100, according to an embodiment, has a fixed-shaft structure in which the shaft 240 is fixedly installed. In accordance with an alternative embodiment, the spindle motor 100 has a shaft structure in which the shaft 240 is removably installed.

Together with the rotating member 250, the shaft 240 forms the bearing clearance B1 in which the lubricating fluid is filled. Further, as illustrated in FIG. 2, the upper thrust member 244 of the shaft 240 forms the sealing part 204 in which the liquid-vapor interface F2 is formed, together with the rotating member 250.

In addition, the upper thrust member 244 is insertedly disposed in an insertion groove 251 of the rotating member 250. An inclined surface 244a is formed at a lower end portion of an outer peripheral surface of the upper thrust member 244 so that the interface between the lubricating fluid and air, for example, the liquid-vapor interface F2, is formed. For example, the liquid-vapor interface F2 is formed in the sealing part 204 formed by the inclined surface 244a and a facing surface of the rotating member 250, which faces the inclined surface 244a.

In addition, the rotor hub 254, the flange part 242, and the upper thrust member 244 of the shaft 240 form a storage space S1 that receives all of the lubricating fluid to fill the bearing clearance B1, together with the facing surface of the rotating member 250.

The storage space S1 refers to a space between a first boundary line x1 and a second boundary line x2 as illustrated in FIG. 3 and has a region in which force applied to the liquid-vapor interface F2 is increased by a capillary phenomenon and gravity at a time of flowing or leakage of the lubricating fluid filling the bearing clearance B1.

In one embodiment, the storage space S1 includes a first storage space S1a connected with the sealing part 204 and extending in the axial direction, a second storage space S1b connected with the first storage space S1a and having a gap increasing upwardly in the axial direction, and a third storage space S1c connected with the second storage space S1b and having a gap wider than the first storage space S1a.

Therefore, when the lubricating fluid is introduced into the storage space S1, as the lubricating fluid is leaked, force applied to the liquid-vapor interface F2 due to a capillary phenomenon gradually increases.

The detailed description thereof will be provided below.

Further, the storage space S1 has a volume sufficient to receive all the lubricating fluid filling the bearing clearance B1. In other words, the storage space S1 is formed to have a volume greater than that of the lubricating fluid filling the bearing clearance B1.

In addition, a lower surface of the upper thrust member 244 and a facing surface of the rotating member 250 facing the lower surface of the upper thrust member 244 form a flow suppression clearance C1.

The flow suppression clearance C1 is connected with the sealing part 204 and disposed in the bearing clearance B1. Further, the flow suppression clearance C1 includes a gap narrower than gaps of other portions of the bearing clearance B1.

As an example, the flow suppression clearance C1 is formed to have a gap of 25 μm or less in order to prevent leakage of the lubricating fluid due to a pressure differential between the flow suppression clearance C1 and the bearing clearance B1 having a level of 2 KPa.

In one example, as shown in FIG. 2, when a pressure P1 is applied to the liquid-vapor interface F1 disposed in the sealing part 202, formed between the lower thrust member 230 and the rotating member 250, and a pressure P2 is applied to the liquid-vapor interface F2 disposed in the sealing part 204 formed between the upper thrust member 244 and the rotating member 250, a pressure differential between P1 and P2 is defined as P1−P2. When P1 is greater than P2, a pressure is applied to outside of the bearing clearance B1 in the liquid-vapor interface F2, such that the liquid-vapor interface F2 is moved up towards the exterior of the sealing part 204.

Further, when the lubricating fluid leaks out from the bearing clearance B1 due to the pressure differential between P1 and P2, the flow suppression clearance C1 prevents the lubricating fluid from leaking from the storage space S1 and scattered to an outside portion of the storage space S1. The detailed description thereof will be provided below.

The rotor 220 includes the rotating member 250 and the cap member 260.

The rotating member 250 rotates based on the shaft 240. In addition, an insertion groove 251 inserted into which the upper thrust member 244 of the shaft 240 is formed in the rotating member 250.

Furthermore, the rotating member 250 includes a sleeve 252 forming the bearing clearance B1 filled with the lubricating fluid, together with the lower thrust member 230 and the shaft 240, and the rotor hub 254 (see FIG. 1) extended from the sleeve 252.

Here, terms with respect to directions will be defined. As viewed in FIG. 1, an axial direction refers to a vertical direction, for example, a direction from a lower end portion of the shaft 240 toward an upper end portion thereof or a direction from the upper end portion of the shaft 240 toward the lower end portion thereof. A radial direction refers to a horizontal direction, for example, a direction from the shaft 240 toward an outer peripheral surface of the rotor hub 254 or a direction from the outer peripheral surface of the rotor hub 254 toward the shaft 240.

A circumferential direction refers to a rotation direction, clockwise or counter-clockwise, along the outer peripheral surfaces of the shaft 240 and the rotor hub 254.

In one configuration, the sleeve 252 is disposed between the flange part 242 and the upper thrust member 244 of the shaft 240 and the lower thrust member 230 and form the bearing clearance B1 together with the shaft 240 and the lower thrust member 230. Further, a shaft hole 252a, through which the shaft 240 penetrates, is formed in the sleeve 252.

In addition, upper and lower radial dynamic pressure grooves (not shown) may be formed in at least one of an inner peripheral surface of the sleeve 252 or the outer peripheral surface of the shaft 240. The upper and lower radial dynamic pressure grooves may be spaced apart from each other in the axial direction at a predetermined interval, and generate hydrodynamic pressure in the radial direction at the time the sleeve 252 rotates to enable the rotating member 250 to stably rotate.

The upper and lower radial dynamic pressure grooves may have, for example, a herringbone shape.

In addition, a thrust dynamic pressure groove (not shown) may be formed in at least one of a lower surface of the sleeve 252 and an upper surface of the disk part 232 of the lower thrust member 230 facing the lower surface of the sleeve 252. The thrust dynamic pressure groove may generate hydrodynamic pressure in the axial direction at the time of rotation of the sleeve 252. The rotating member 250 rotates while being suspended above the lower thrust member 230 at a predetermined height.

A circulation hole 252b is formed in the sleeve 252 and connects a bearing clearance, which is formed by an upper surface of the sleeve 252 and the flange part 242 of the shaft 240, with a bearing clearance, which is formed by the lower surface of the sleeve 252 and the facing surface of the lower thrust member 230.

The rotor hub 254 extends from the sleeve 252 as illustrated in more detail in FIG. 1. Although in one embodiment the rotor hub 254 and the sleeve 252 are integrally formed integrally an alternative embodiment may include the rotor hub 254 and the sleeve 252 directed connected or operatively connected to each other. The rotor hub 254 and the sleeve 252 may be separately manufactured and subsequently assembled.

The rotor hub 254 includes a body 254a having a disk shape, a magnet mounting part 254b extended downwardly from an edge of the body 254a in the axial direction, and a disk support part 254c extended from a distal end of the magnet mounting part 254b in the radial direction, as illustrated in FIG. 1.

In addition, the driving magnet 130 is fixedly attached to an inner surface of the magnet mounting part 254b. In an alternative configuration, the driving magnet 130 is removably attached to the inner surface of the magnet mounting part 254b. An inner surface of the driving magnet 130 is disposed to face the stator core 120.

In accordance with one example, a rotational driving scheme of the rotating member 250 will be simply described. When power is applied to the coil 122 wound around the stator core 120, a driving force rotating the rotating member 250 is generated by electromagnetic interaction between the stator core 120 including the coil 122 wound therearound and the driving magnet 130, thereby rotating the rotating member 250.

For example, the rotating member 250 is rotated by the electromagnetic interaction between the driving magnet 130 and the stator core 120 including the coil 122 wound therearound and disposed to face the driving magnet 130.

In addition, an installation groove part 255 is formed in an upper surface of the body 254a to be disposed upwardly in the axial direction. A cap member 260 to prevent the lubrication fluid from scattering is installed in the installation groove part 255.

As described above, leakage of the lubricating fluid to the outside due to the pressure differential between P1 and P2 may be prevented by a combination of, for example, the storage space S1 and the flow suppression clearance C1.

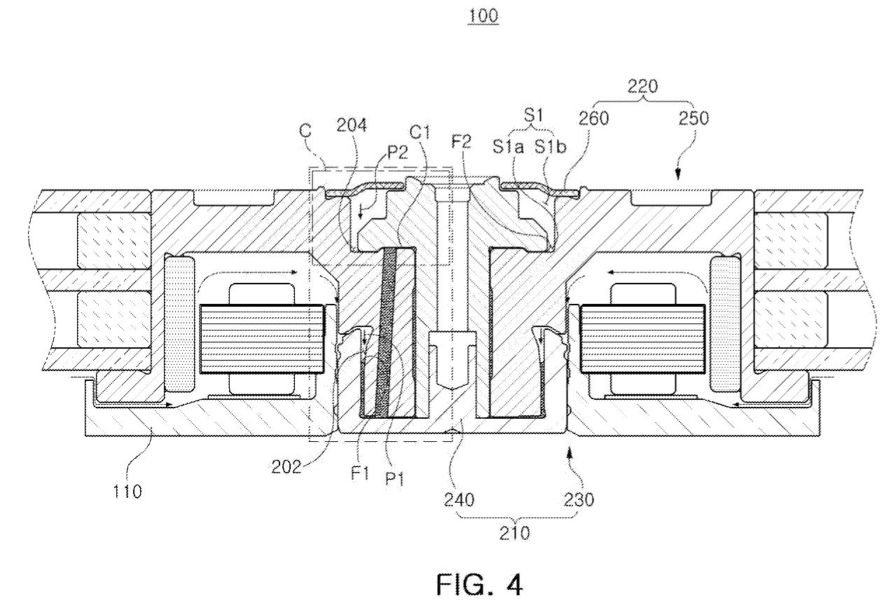

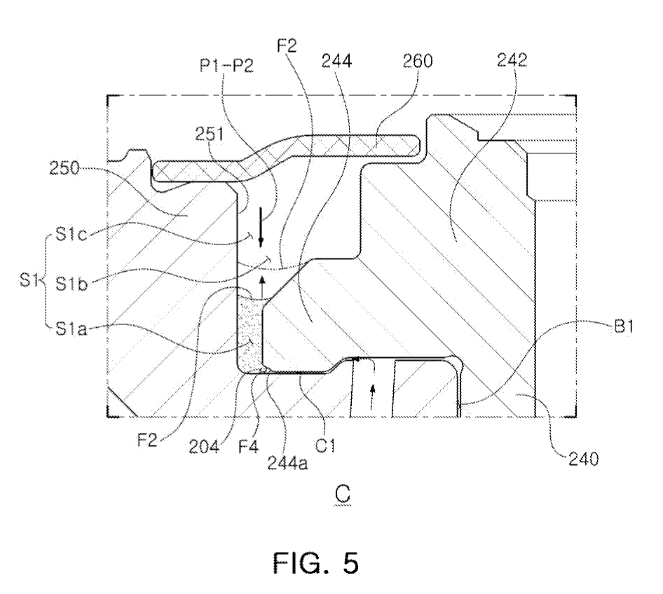

FIG. 4 is a view illustrating an operation of the spindle motor including the hydrodynamic bearing device, according to an embodiment, and FIG. 5 is an enlarged view illustrating part C of FIG. 4.

FIG. 4 illustrates a structural mechanism that forms liquid-vapor interfaces F1 and F2. In this example, a principle of a lubricating fluid filling the bearing clearance B1 is described after a predetermined time elapses and after the lubricating fluid is injected into the storage space S1. The lubricating fluid may be introduced into the bearing clearance B1 through a capillary phenomenon. The capillary phenomenon is a phenomenon generated by a difference between cohesive force of the lubricating fluid and adhesion force between surfaces forming the bearing clearance B1 and the lubricating fluid.

In addition, because the adhesion force is stronger than cohesive force of the lubricating fluid, the liquid-vapor interface is formed in a concave shape. Further, the lubricating fluid may be continuously introduced until amounts of force applied to the liquid-vapor interfaces F1 and F2 formed at both sides are equalized by the capillary phenomenon.

The lubricating fluid injected into the storage space S1 is introduced into the bearing clearance B1 using the capillary phenomenon, and the lubricating fluid flows until amounts of force applied to the liquid-vapor interfaces F1 and F2 formed by the capillary phenomenon equalize. Thereafter, the liquid-vapor interfaces F1 and F2 are formed in the sealing parts 202 and 204, respectively.

Further, as illustrated in FIG. 4, when performing a blowing process in an assembly process in a space that is formed by the rotating member 250 and the base member 110 after the lubricating fluid fills the bearing clearance B1, the pressure P1 applied to the liquid-vapor interface F1 disposed in the sealing part 202 increases. As shown in FIG. 4, the sealing part 202 is formed by the lower thrust member 230 and the sleeve 252 of the rotating member 250 may be increased.

In one configuration, the pressure P1 applied to the liquid-vapor interface F1, which is disposed in the sealing part 202 formed by the lower thrust member 230 and the sleeve 252 of the rotating member 250, becomes greater than the pressure P2 applied to the liquid-vapor interface F2, which is disposed in the sealing part 204 formed by the upper thrust member 244 and the sleeve 252 of the rotating member 250.

When P1 is greater than P2 as described above, the lubricating fluid filling the bearing clearance B1 passes through the sealing part 204 into the storage space S1 as illustrated in FIG. 5.

The lubricating fluid flowing from the bearing clearance B1 passes through the flow suppression clearance C1. The flow suppression clearance C1 is formed to have a gap narrower than those of other portions of the bearing clearance B1, such that when the lubricating fluid passes through the flow suppression clearance C1, force is applied to the lubricating fluid in a direction opposite to a direction in which the lubricating fluid is allowed to flow.

Further, when the lubricating fluid flows or is leaked into the storage space S1, force applied to the liquid-vapor interface F2 due to the capillary phenomenon may be gradually increased. In other words, the capillary phenomenon acts in a direction in which a surface area of the lubricating fluid decreases and, accordingly, when an leakage amount or flow amount of the lubricating fluid to the storage space S1 is increased, force applied in a direction opposite to a flow direction of the lubricating fluid by the capillary phenomenon gradually increases.

As a result, the lubricating fluid is leaked or flows from the bearing clearance B1 until a resultant force between a force acting in the direction opposite to the flow direction of the lubricating fluid through the flow suppression clearance C1, and of a force acting on the liquid-vapor interface F2 in the direction opposite to the flow direction of the lubricating fluid by the capillary phenomenon is equal to a force applied to the lubricating fluid due to the pressure differential.

The storage space S1 has a volume lager than a filling amount of the lubricating fluid filling the bearing clearance B1, such that a flow or a leakage of the lubricating fluid into the storage space S1 is decreased.

For example, when the lubricating fluid is leaked from the bearing clearance B1 due to the pressure differential, the liquid-vapor interface F2 moves until the resultant force of the force applied to the liquid-vapor interface F2 by the capillary phenomenon and the force applied in the direction opposite to the flow direction of the lubricating fluid through the flow suppression clearance C1 is equal to the force due to the pressure differential. In one illustrative example, the liquid-vapor interface F2 is disposed in the storage space S1.

Further, when a pressure differential due to an external factor disappears, the lubricating fluid introduced into the storage space S1 may be re-introduced into the bearing clearance B1 as a result of the capillary phenomenon.

Thus, the scattering of the lubricating fluid due to the pressure differential is prevented through the flow suppression clearance C1 and the storage space S1. In addition, contamination of a disk caused by leakage of the lubricating fluid to the outside is decreased.

Hereinafter, a spindle motor, according to another embodiment, will be described with reference to the accompanying drawings.

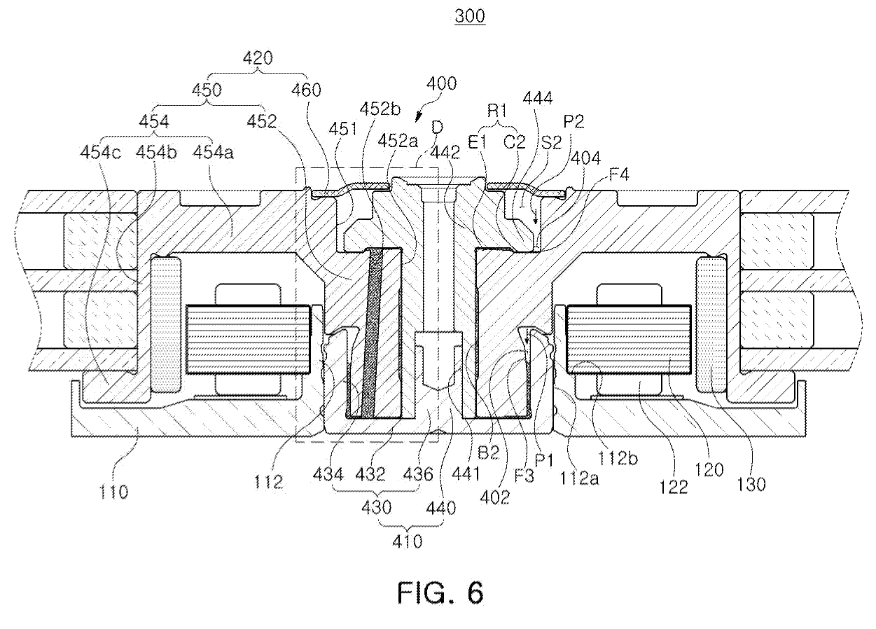

FIG. 6 is a schematic cross-sectional view illustrating a spindle motor including a hydrodynamic bearing device, according to another embodiment.

Referring to FIG. 6, a spindle motor 300, according to another embodiment, includes a base member 110, a stator core 120, a driving magnet 130, and a hydrodynamic bearing device 400.

The base member 110, the stator core 120, and the driving magnet 130 correspond to the same configurations as those provided in the above-mentioned spindle motor 100, according to the foregoing embodiment and; thus, a detailed description thereof will be omitted.

The hydrodynamic bearing device 400 includes a stator 410 and a rotor 420. The stator 410 and the rotor 420 form a bearing clearance B2 filled with a lubricating fluid. The stator 410 includes a lower thrust member 430 and a shaft 440, and the rotor 420 includes a rotating member 450 and a cap member 460.

Because configurations of the hydrodynamic bearing device 400, according to another embodiment, are the same as those of the above-mentioned hydrodynamic bearing assembly 200, except for portions to be described below, a detailed description thereof will be replaced by the description of the above-mentioned hydrodynamic bearing assembly 200, and; thus, be omitted below.

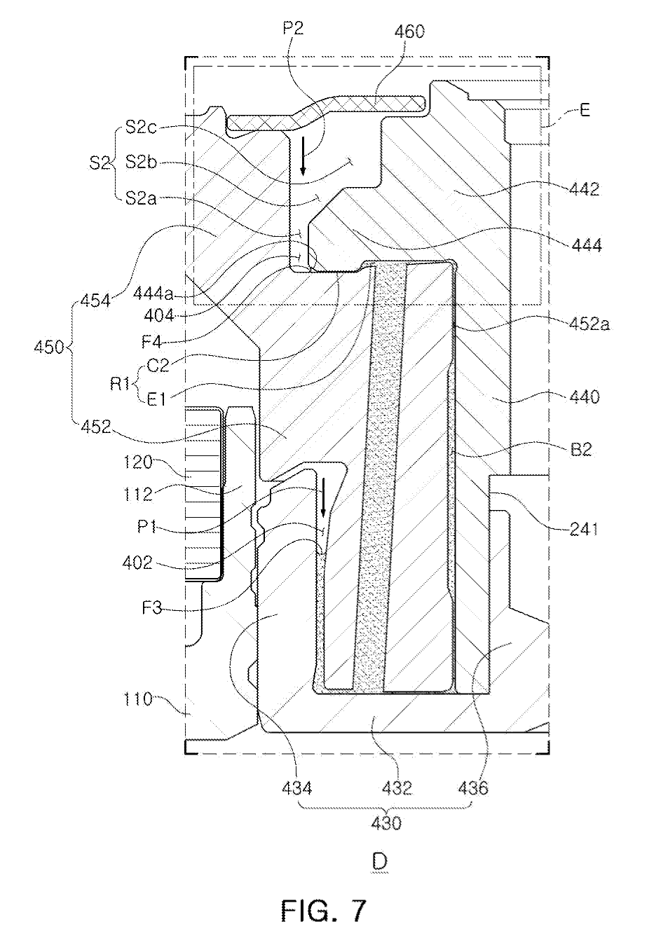

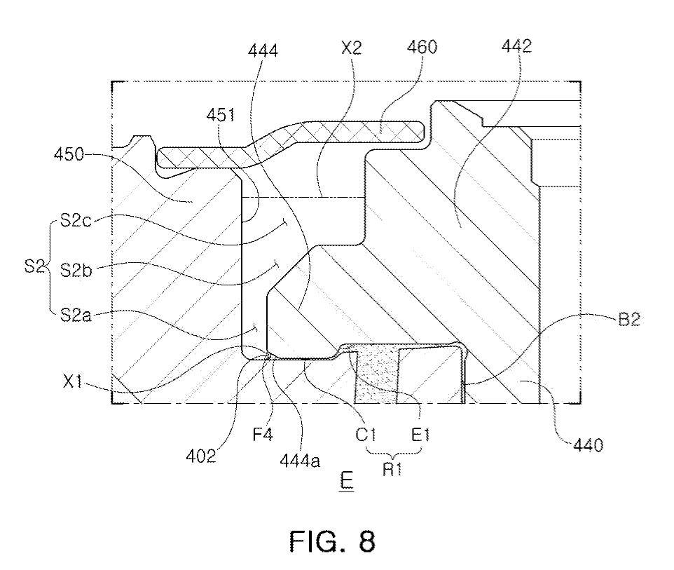

The hydrodynamic bearing device 400 will be described in more detail with reference to FIGS. 7 and 8.

FIG. 7 is an enlarged view of part D of FIG. 6, and FIG. 8 is an enlarged view illustrating part E of FIG. 7.

Referring to FIGS. 7 and 8, the stator 410 and the rotor 420 form the bearing clearance B2 filled with the lubricating fluid. Sealing parts 402 and 404 are connected with the bearing clearance B2 and include liquid-vapor interfaces F3 and F4 disposed therein.

Furthermore, the stator 410 and the rotor 420 form a storage space S2 connected with the sealing part 404 and receiving all the lubricating fluid filling the bearing clearance B2 at the time of the lubricating fluid filling the bearing clearance B2.

A detailed description of the storage space S2 is provided below.

The shaft 440 has a lower end portion fixedly attached to the lower thrust member 430 and includes a flange part 442 and an upper thrust part 444 formed at an upper end portion thereof. For example, the spindle motor 300, according to another embodiment, has a fixed-shaft structure in which the shaft 440 is fixedly installed. In an alternative configuration, the spindle motor 300 has a shaft structure in which the shaft 440 is a removable shaft.

The shaft 440 forms the bearing clearance B2 filled with the lubricating fluid, together with the rotating member 450.

The upper thrust member 444 forms the sealing part 404 in which the liquid-vapor interface F4 is formed, together with the rotating member 450.

In addition, the upper thrust part 444 is insertedly disposed in an insertion groove 451 of the rotating member 450. An inclined surface 444a is formed at a lower end portion of an outer peripheral surface of the upper thrust part 444 so that the interface between the lubricating fluid and air, for example, the liquid-vapor interface F4, may be formed.

For example, the liquid-vapor interface F4 is formed in the sealing part 404 formed by the inclined surface 444a and a surface of the rotating member 450 facing the inclined surface 444a.

In addition, the flange part 442 and the upper thrust part 444 form the storage space S2, which receives the lubricating fluid to fill the bearing clearance B2 at the time the lubricating fluid filling the bearing clearance B2, together with the rotating member 450.

The storage space S2 is a space between a first boundary line x1 and a second boundary line x2 as illustrated in FIG. 8.

As an example, the storage space S2 includes a first storage space S2a connected with the sealing part 404 extending in the axial direction, a second storage space S2b connected with the first storage space S2a and having a gap increasing upwardly in the axial direction, and a third storage space S2c connected with the second storage space S2b and having a gap wider than the first storage space S2a.

Therefore, when the lubricating fluid is introduced into the storage space S2, as the lubricating fluid flows or is leaked, force applied to the liquid-vapor interface F4 through a capillary phenomenon is gradually increased.

Further, the storage space S2 has a volume large enough to receive all the lubricating fluid filling the bearing clearance B2. In other words, the storage space S2 is formed to have a volume greater than an amount of the lubricating fluid filling the bearing clearance B2.

In addition, a sealing reinforcement part R1 forming a labyrinth seal in connection with the sealing part 404 and having a gap of variable size and formed in the bearing clearance B2.

The sealing reinforcement part R1 includes a flow suppression clearance C2 connected with the sealing part 404 and suppressing a flow of the lubricating fluid. The sealing reinforcement part R1 also includes a clearance expansion part E1 connected with the flow suppression clearance C2 and having a gap wider than that of the flow suppression clearance C2.

The clearance expansion part E1 is formed so that a gap of a portion thereof connected with the flow suppression clearance C2 is widest, and as a distance from the flow suppression clearance C2 is increased, the gap is further decreased. For example, the clearance expansion part E1 is formed to be tapered so that the gap is increased toward the flow suppression clearance C2.

A flow speed of the lubricating fluid flowing is decreased through the sealing reinforcement part R1 as described above, such that a movement of the liquid-vapor interface F4 is further reduced by a force applied to the liquid-vapor interface F4 as a result of the capillary phenomenon.

In one illustrative example, the flow suppression clearance C2 is formed to have a gap of 25 μm or less in order to prevent leakage of the lubricating fluid due to a level of pressure differential of 2 KPa. Further, in an example, the flow suppression clearance C2 includes a gap narrower than gaps of other portions of the bearing clearance B2.

The rotor 420 includes the rotating member 450 and the cap member 460. Because the rotating member 450 and the cap member 460 are the same as the above-mentioned rotating member 250 and cap member 260 of the spindle motor 100, according to the foregoing embodiment, except for portions to be described below, a detailed description thereof will be replaced by the above-mentioned description and be omitted below.

The rotating member 450 includes a sleeve 452 forming the bearing clearance B2 filled with the lubricating fluid, together with the lower thrust member 430 and the shaft 440 and a rotor hub 454 (see FIG. 6) extended from the sleeve 452.

At least one of an upper surface of the sleeve 452 and a lower surface of the flange part 442 of the shaft 440 disposed to face the upper surface of the sleeve 452 is inclined in order to form the clearance expansion part E1.

Hereinafter, an operation of the hydrodynamic bearing device, according to another embodiment, will be described with reference to the accompanying drawings.

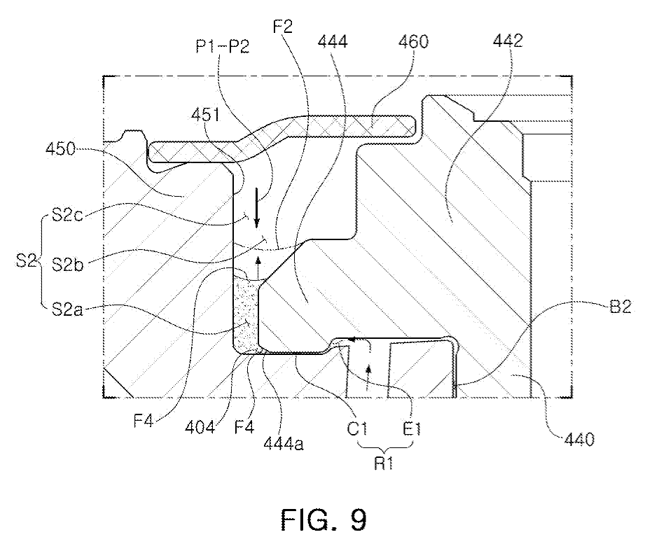

FIG. 9 is a view illustrating an operation of the hydrodynamic bearing device, according to another embodiment.

FIG. 9 illustrates an embodiment of performing a blowing process in an assembly process. In this embodiment, the lubricating fluid fills the bearing clearance B2 and a pressure differential (P1>P2) is applied. The lubricating fluid filling the bearing clearance B2 passes through the sealing reinforcement part R1 and the sealing part 404 to be introduced into the storage space S2.

Therefore, a flow speed of the lubricating fluid passing through the sealing reinforcement part R1 is decreased, and when the lubricating fluid passes through the flow suppression clearance C2 of the sealing reinforcement part R1, a force in a direction opposite to a direction in which the lubricating fluid is allowed to flow is applied to the lubricating fluid.

Further, when the lubricating fluid flows or is leaked into the storage space S2, force applied to the liquid-vapor interface F4 by the capillary phenomenon is gradually increased.

As a result, the lubricating fluid is leaked from the bearing clearance C2 until a resultant force of a force, which acts in the direction opposite to a flow direction of the lubricating fluid by the flow suppression clearance B2, and a force, which acts on the liquid-vapor interface F4 moved to the storage space S2 in the direction opposite to the flow direction of the lubricating fluid by the capillary phenomenon, becomes equal to a force applied to the lubricating fluid due to the pressure differential.

In addition, because the lubricating fluid passes through the sealing reinforcement part R1 and then is introduced into the storage space S2, a leakage speed of the lubricating fluid is decreased, such that force applied to the liquid-vapor interface F4 by the capillary phenomenon may be more stably applied.

Hereinafter, a recording disk driving device, according to an embodiment, will be described with reference to the accompanying drawing.

FIG. 10 is a schematic cross-sectional view illustrating a recording disk driving device, according to an embodiment.

Referring to FIG. 10, a recording disk driving device 500, according to an embodiment, includes a spindle motor 520, a head transfer part 540, and an upper case 560.

The spindle motor 520 may be any one of the above-mentioned spindle motors according to an embodiment and another embodiment, and a recording disk D may be mounted on the spindle motor 520.

The head transfer part 540 transfers a head 542 detecting information of the recording disk D mounted on the spindle motor 520 to a surface of the recording disk D from which information is to be read. The head 542 is disposed on a support part 544 of the head transfer part 540.

The upper case 560 is assembled with a base member 522 to form an internal space for accommodating the spindle motor 520 and the head transfer part 540 therein.

As set forth above, according to various embodiments, the scattering of the lubricating fluid is prevented.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A hydrodynamic bearing device, comprising:
a stator; and
a rotor forming a bearing clearance and a sealing part connected with the bearing clearance, wherein a liquid-vapor interface is disposed in the sealing part together with the stator, and the bearing clearance is filled with a lubricating fluid,
wherein the stator and the rotor form a storage space connected with the sealing part to receive the lubricating fluid, and
wherein the storage space has a region in which force applied to the liquid-vapor interface increases by a capillary phenomenon at a time that the lubricating fluid leaks to fill the bearing clearance.

2. The hydrodynamic bearing device of claim 1, wherein the storage space has a volume equal to or greater than a volume of the lubricating fluid filling the bearing clearance.

3. The hydrodynamic bearing device of claim 1, wherein the storage space comprises
a first storage space formed in an axial direction,
a second storage space connected with the first storage space and having a gap increasing upwardly in the axial direction, and
a third storage space connected with the second storage space and having a gap wider than a gap of the second storage space.

4. The hydrodynamic bearing device of claim 1, wherein the bearing clearance comprises a flow suppression clearance having a gap narrower than gaps of other portions of the bearing clearance to suppress of a flow of the lubricating fluid.

5. The hydrodynamic bearing device of claim 4, wherein the flow suppression clearance is formed in the bearing clearance to be connected with the sealing part.

6. A hydrodynamic bearing device, comprising:
a stator; and
a rotor forming a bearing clearance and a sealing part connected with the bearing clearance, wherein
a liquid-vapor interface is disposed in the sealing part together with the stator, and the bearing clearance is filled with a lubricating fluid,
the stator and the rotor form a storage space connected with the sealing part to receive the lubricating fluid leaked from the bearing clearance, and
the bearing clearance comprises a sealing reinforcement part formed therein, forming a labyrinth seal with the sealing part and comprising a gap of variable size.

7. The hydrodynamic bearing device of claim 6, wherein the storage space has a region in which force applied to the liquid-vapor interface increases by a capillary phenomenon as the lubricating fluid leaks.

8. The hydrodynamic bearing device of claim 6, wherein the sealing reinforcement part comprises
a flow suppression clearance connected with the sealing part and having a gap narrower than a gap of the sealing part, and
a clearance expansion part connected with the flow suppression clearance and having a gap wider than a gap of the flow suppression clearance.

9. The hydrodynamic bearing device of claim 8, wherein the clearance expansion part is formed to be inclined from a portion of the clearance expansion part connected with the flow suppression clearance.

10. The hydrodynamic bearing device of claim 9, wherein the flow suppression clearance has a gap narrower than gaps of other portions of the bearing clearance.

11. A spindle motor, comprising:
a base member;
a lower thrust member connected to the base member;
a shaft connected to the lower thrust member and including an upper thrust member extended from a flange part at an upper end portion of the shaft; and
a rotating member configured to form a bearing clearance together with the lower thrust member and the shaft, wherein
the bearing clearance is filled with a lubricating fluid,
the upper thrust member and the flange part form a storage space configured to receive the lubricating fluid filling the bearing clearance, together with the rotating member, and
a lower surface of the upper thrust member and a surface of the rotating member facing the lower surface of the upper thrust member form a flow suppression clearance.

12. The spindle motor of claim 11, wherein the storage space has a region in which force applied to a liquid-vapor interface moved due to the leakage of the lubricating fluid by a capillary phenomenon is increased.

13. The spindle motor of claim 11, wherein the flow suppression clearance is disposed in the bearing clearance and has a gap narrower than gaps of other portions of the bearing clearance.

14. The spindle motor of claim 13, wherein the flow suppression clearance is connected with a sealing part formed at a distal end of the bearing clearance and the storage space is extended from the sealing part.

15. The spindle motor of claim 14, wherein the bearing clearance comprises a sealing reinforcement part including the flow suppression clearance and a clearance expansion part connected with the flow suppression clearance and having a gap wider than a gap of the flow suppression clearance, wherein
the sealing reinforcement part forms a labyrinth seal in connection with the sealing part and includes a gap of a variable size.

16. The spindle motor of claim 11, wherein the flow suppression clearance has a gap of 25 μm or less to prevent scattering of the lubricating fluid due to a pressure differential of 2 KPa.

17. The spindle motor of claim 11, wherein the storage space comprises
a first storage space formed in an axial direction,
a second storage space connected with the first storage space and having a gap increasing upwardly in the axial direction, and
a third storage space connected with the second storage space and having a gap wider than a gap of the second storage space.

18. A recording disk driving device comprising:
the spindle motor of claim 11 configured to rotate a recording disk;
a head transfer part transferring a head detecting information of the recording disk mounted on the spindle motor to the recording disk; and
an upper case assembled with the base member to form an internal space to receive the spindle motor and the head transfer part.

19. A hydrodynamic bearing device, comprising:
a stator comprising a lower thrust member and a shaft; and
a rotor forming a bearing clearance and a first sealing part connected with the bearing clearance, wherein
a liquid-vapor interface is disposed in the first sealing part together with the stator, and the bearing clearance is filled with a lubricating fluid,
the stator and the rotor form a storage space connected with the first sealing part to receive the lubricating fluid, and
a lower surface of an upper thrust member of the shaft and a facing surface of a rotating member of the rotor facing the lower surface of the upper thrust member form a flow suppression clearance,
the first sealing part is formed between the upper thrust member and the rotating member,
a second sealing part is formed between the lower thrust member and the rotating member, and
when a pressure, P1, is applied to a first liquid-vapor interface disposed in the second sealing part and a pressure, P2, is applied to a second liquid-vapor interface disposed in the first sealing part, a pressure differential between P1 and P2 is defined as P1−P2.

20. The hydrodynamic bearing device of claim 19, wherein the storage space comprises a volume greater than a volume of the lubricating fluid filling the bearing clearance.

21. The hydrodynamic bearing device of claim 19, wherein when P1 is greater than P2, a pressure is applied to outside of the bearing clearance in the second liquid-vapor interface, moving up the second liquid-vapor interface towards the exterior of the first sealing part.

22. The hydrodynamic bearing device of claim 19, wherein the flow suppression clearance is connected with the first sealing part and disposed in the bearing clearance.

23. The hydrodynamic bearing device of claim 19, wherein the flow suppression clearance includes a gap narrower than gaps of other portions of the bearing clearance.

24. The hydrodynamic bearing device of claim 19, wherein as the lubricating fluid leaks into the storage space, force applied to the liquid-vapor interface by the capillary phenomenon is gradually increased.

25. The hydrodynamic bearing device of claim 24, wherein the lubricating fluid is leaked from the bearing clearance until a pressure differential of a force, which acts in a direction opposite to a flow direction of the lubricating fluid by the flow suppression clearance, and a force, which acts on the liquid-vapor interface moved to the storage space in the direction opposite to the flow direction of the lubricating fluid by the capillary phenomenon, becomes equal to a force applied to the lubricating fluid.

26. The hydrodynamic bearing device of claim 19, wherein a leakage speed of the lubricating fluid decreases as the lubricating fluid passes through a sealing reinforcement part and is introduced into the storage space.
